(19) United States
(12) Patent Application Publication
(10) Pub. No.: US 2010/0279253 A1
(43) Pub. Date: Nov. 4, 2010

(54) SELF-CONTAINED DENTAL TOOL WITH EXTENDABLE HANDLE

(76) Inventor: Larry Fishman, Highland Lake, NY (US)

Correspondence Address: THOMPSON HINE L.L.P.;Intellectual Property Group, P.O. BOX 8801, DAYTON, OH, 45401-8801, US

(21) Appl. No.: 12/834,093

(22) Filed: Jul. 12, 2010

Related U.S. Application Data
(62) Division of application No. 11/904,072, filed on Sep. 26, 2007.

(51) Int. Cl. A61C 3/00

(52) U.S. Cl. 433/141

(57) ABSTRACT

A compact dental appliance includes a protective cap which is reversibly attachable to either end of the appliance, so that removal of the cap exposes a dental hygiene tool, and re-attachment of the cap to the appliance in the opposite orientation re-configures the cap as a handle or handle extension. In preferred embodiments, a plurality of reversibly attachable dental hygiene tools is provided.

This application is a divisional application of U.S. application Ser. No. 11/904,072 entitled SELF-CONTAINED DENTAL TOOL WITH EXTENDABLE HANDLE, filed on Sep. 26, 2007, the entire contents of which are incorporated by reference herein.

This invention relates generally to dental hygiene appliances, and more particularly to self-contained, compact appliances adaptable to multiple oral hygiene tasks.

### BACKGROUND

The longstanding need of travelers for portable personal dental hygiene appliances has led to the development of a variety of appliances, such as dental picks (e.g., U.S. Pat. Nos. 4,326,548 and D350,415); dental scalers and tongue cleansers (e.g., U.S. Pat. No. D354,624); stain removers (e.g., U.S. Pat. No. 5,118,291); interdental stimulators (e.g., U.S. Pat. No. D110,936); interproximal brushes (e.g., U.S. Pat. Nos. 5,029,358, 6,325,626 and 7,156,107); flossers (e.g., U.S. Pat. Nos. 5,881,745, 5,538,023 and 4,006,750); and multifunctional dental appliances combining two or more of the foregoing dental tools (e.g., U.S. Pat. Nos. D531,812 and 6,247,477).

In order to render these personal oral hygiene tools more portable and less conspicuous, they have in general been designed to be as compact as possible. However, as the designs become more compact, they become more difficult to use. Anyone who has attempted to apply a three-inch-long travel toothbrush or dental pick to the back molars is familiar with this problem.

There remains a need for portable, personal oral hygiene tools that are compact and inconspicuous, while still affording the ease of use associated with a full-sized device.

### BRIEF DESCRIPTION OF THE INVENTION

The present invention is a compact dental appliance which includes a protective cap which is reversibly attachable to either end of the appliance, so that removal of the cap exposes a dental hygiene tool, and re-attachment of the cap to the opposite end of the appliance re-configures the cap as a handle or handle extension.

The dental appliance of the invention is well-adapted to being carried about in a person's pocket or purse. In preferred embodiments, the appliance presents the inconspicuous appearance of a writing implement when not in use.

### BRIEF DESCRIPTION OF DRAWINGS

The accompanying drawings are provided in order to illustrate, by way of example, some of the possible embodiments of the invention:

FIG. 1 is a perspective view of a dental appliance constructed in accordance with one embodiment of the invention, illustrating a pen-shaped cap and a dental scaler projecting from a carrier at an end of the appliance body.

FIG. 2 is a perspective view of a dental appliance constructed in accordance with an alternative embodiment of the invention, in which a single set of screw threads may engage the cap in either of two orientations.

FIG. 3 is a sectional view through a dental appliance constructed in accordance with one embodiment of the invention, with the cap in place over the dental tool, and illustrating a second tool having a dental pick implement at the other end of the attachment.

FIG. 4 is a sectional view through a dental appliance constructed in accordance with one embodiment of the invention, having an attachment with a dental pick at one end, where the attachment bears the means for affixing the cap.

### DETAILED DESCRIPTION OF THE INVENTION

In general terms, the invention is a self-contained dental appliance, which comprises a generally tubular body having a hollow interior, a first end, and a second end. The expression “generally tubular” refers to an elongated, mostly hollow configuration which may be closed at one or both ends, which may or may not have a circular cross-section, and whose cross-section may vary along the length of the body.

An attachment, comprising an axially-projecting oral hygiene dental tool, is affixed to the first end of the appliance body. In one embodiment, the appliance body bears a single set of spiral threads which may engage complementary threads in the open end of a generally tubular cap, the spiral threads being located at such a distance from either end as to permit the cap to be affixed in either of two orientations. In a second embodiment, either the first end of the appliance body, or the attachment, bears a first means for reversibly affixing the cap, and the second end of the appliance body bears a second means for reversibly affixing the cap. The cap has a hollow interior, a first end, and a second end, with the first end being open in order to fit over the dental tool. The first end of the cap bears means for reversibly affixing the cap to the appliance body and/or to the attachment, so as to cover the dental tool and protect it from damage and contamination. The cap is preferably closed at the second end.

In a preferred embodiment, the attachment is reversibly affixed to the first end of the appliance body, so that other attachments bearing different dental tools may be attached. In a particularly preferred embodiment, the attachment bears a second axially projecting dental tool, projecting in the opposite direction of the first dental tool, and is reversibly affixable to the appliance body in two orientations, so that one tool is available for use while the other tool is stored within the tubular body of the appliance. Suitable dental tools for use with the appliance of the invention may be any of a number of dental hygiene implements, including but not limited to picks, scalers, interproximal brushes, prophy cups, burnishing heads, interdental stimulators, stain removers, toothbrush heads, and the like. The means for reversibly affixing the attachment to the appliance body may be any known in the art, for example a friction fit, screw thread, or the like. In the figures, the use of a simple friction fit is illustrated, where the attachment is pressed into the open end of the appliance body.

In yet another embodiment, the attachment comprises a dental tool reversibly affixed to a tool carrier, so that other dental tools may be affixed to the carrier. In a preferred embodiment, these other dental tools may be stored within the hollow appliance body. The tool carrier is designed to be reversibly attachable to the appliance body, by any means known in the art, for example a friction fit, screw thread, or the like. In the figures, the use of a simple friction fit is illustrated, where the tool carrier is pressed into the open end of the appliance body. In this embodiment, the dental tools are likewise designed to be reversibly attachable to the tool carrier, by any means known in the art, as shown for example in U.S. Pat. No. 6,247,477.

In the appliance of the present invention, the first end of the cap and both ends of the appliance body bear mechanically complementary means for reversibly affixing the cap to the ends of the appliance body, so that the cap covers the dental tool when it is affixed to the first end of the body, and serves as a handle for the user of the appliance to grasp when it is affixed to the opposite end of the body. Suitable means for reversibly affixing the cap include but are not limited to screw threads, twist-and-lock attachments, friction fittings (optionally with elastomeric sealing elements such as O-rings), and “snap-on” compression fittings (e.g., designs employing annular ridges and/or grooves), as are well-known in the mechanical arts.

Friction fittings, wherein the cap is pressed onto an appliance body of slightly lesser diameter (with at least one component featuring some degree of taper), are suitable in embodiments where little force is applied during use of the dental tool, as in the case of a brush. However, friction fittings are less suitable where a rigid and mechanically firm attachment is necessary, for example where the tool is a dental pick, which requires accurate placement and the application of moderate force. A multifunction appliance, where one of the tools may be a pick, likewise requires a rigid and firm means of attachment. For this reason, the preferred means for reversibly affixing the cap to the end of the appliance body is a means other than a friction fit, and is more preferably complementary screw threads. Most preferably, the means employs male threads on the body and complementary female threading within the first end of the cap.

In an alternative embodiment, the attachment, rather than the first end of the appliance body, bears the mechanically complimentary means for reversibly affixing the cap. In this embodiment as well, the preferred means is a male thread.

The cap and body are preferably configured as a cylindrical pen-shaped barrel, with an optional pocket clip, so that the appliance, when the tool is capped, has the general form of a fountain or ball-point pen. In certain embodiments, the appliance may be constructed of an inexpensive plastic such as polystyrene, PVC, or polypropylene, and is intended to be disposable after a limited number of uses. In other embodiments, the appliance may be constructed of more durable polymers, hard rubber (e.g. Ebonite.™), metal, glass, ceramic, or fine wood or stone, or combinations thereof, in order to more closely resemble a high-quality pen. The present invention contemplates the use of any of the materials, means of manufacture, and means of reversibly affixing the cap to the body, that are known and used in the making of ball-point and fountain pens.

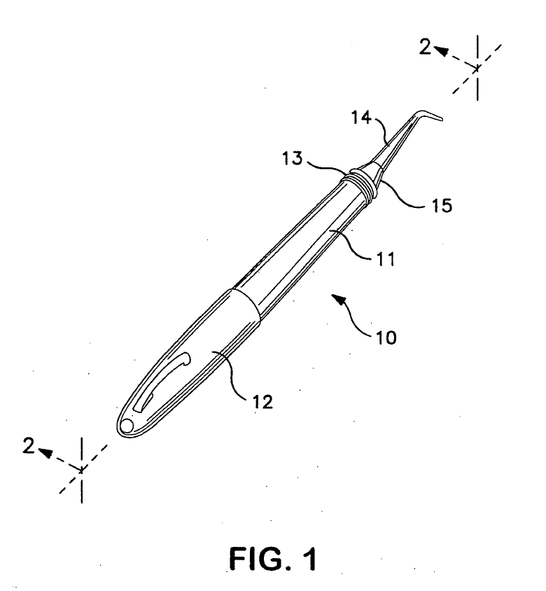

Referring now in detail to the drawings, in FIG. 1 the reference numeral 10 denotes generally a dental appliance constructed in accordance with and embodying the invention. The appliance includes a generally tubular body 11, a cap 12, and male threads 13 which are complementary to female threads within the cap (not shown). The appliance bears an attachment comprising a dental scaler 14 and a tool carrier 15. In FIG. 1, the cap is shown affixed to the second end of the appliance body, via engagement of female threads within the cap with male threads on the second end of the appliance body, thereby together with the body forming a handle for the dental tool.

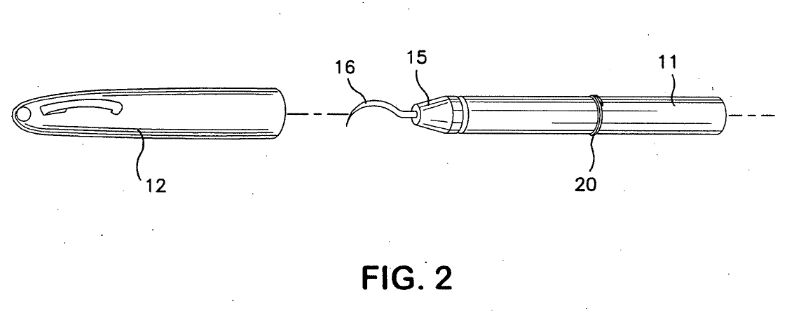

In FIG. 2, the cap 12 is shown removed from the appliance body 11. In this embodiment, spiral threads 20, complementary to female threads within the cap, are disposed about the central region of the body.

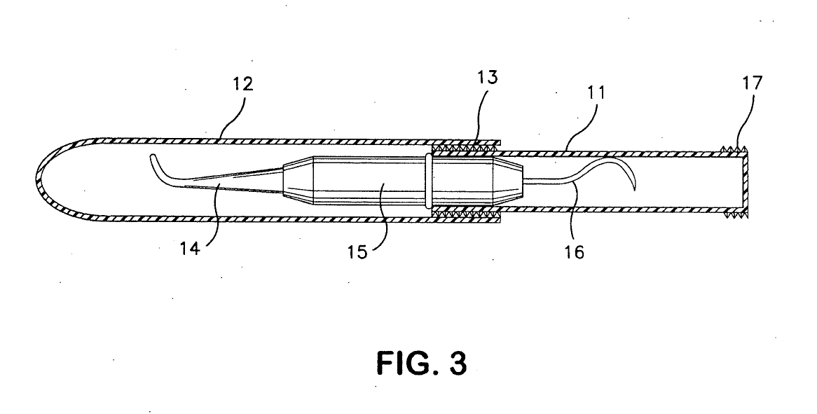

In FIG. 3, the cap 12 and appliance body 11 are shown in longitudinal section, with internal female threads on the cap engaged with the male threads 13 at the first end of the appliance body. At the second end of the body 11 are male threads 17. In this embodiment, tool carrier 15 bears dental scaler 14 projecting axially from one end of the carrier, and a dental pick 16 projecting axially from the other end thereof.

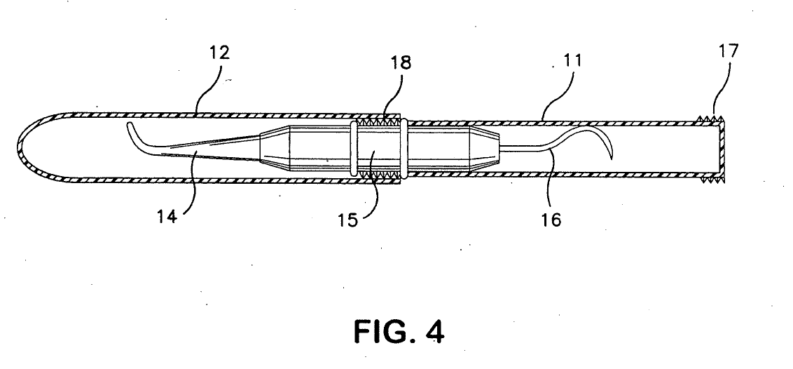

In FIG. 4, the cap 12 and appliance body 11 are shown in cross-section, with the internal female threads of the cap mated to male threads 18 formed on the tool carrier 15. At the second end of the body 11 are male threads 17. In this embodiment, tool carrier 15 bears dental scaler 14 projecting axially from one end thereof and a dental pick 16 projecting axially from the other end thereof.

It should be appreciated that design and use of various dental implements and attachments are well-known to those of skill in the art, for example as disclosed in U.S. Pat. Nos. 4,326,548 and 6,247,477, both of which are incorporated herein by reference in their entireties. The substitution of any such dental implements and attachments is contemplated to be within the scope of the present invention.

The drawings provided herein are intended to illustrate various embodiments of the invention. They are provided by way of example only, and are not intended to describe or constitute limitations to the scope of the invention. In particular, the incorporation of additional dental hygiene tools, and such obvious mechanical substitutions and modifications as are readily apparent to those skilled in the art, are contemplated to be part of the present invention and are intended to be within the scope of the appended claims.

I claim:

1. A self-contained dental appliance comprising:
a generally tubular body having a hollow interior, a first end, and a second end;
an attachment including a first oral hygiene dental tool and a threaded affixing shape, wherein said attachment is affixable at or adjacent to the first end of said generally tubular body;
a generally tubular cap having a hollow interior, a first end, and a second generally closed end, the first end of said cap including a threaded shape mechanically complementary to said affixing shape for removably affixing said cap to said attachment such that said cap generally covers said first oral hygiene dental tool when said attachment is affixed at or adjacent to the first end of said generally tubular body in a first configuration; and
threaded cap receiving structure positioned at or adjacent to said second end of said generally tubular body for receiving said threaded shape of said cap such that said cap is usable as a handle extension when said cap is affixed to said generally tubular body at or adjacent to said second end of said generally tubular body in an axially opposite second configuration.

2. The dental appliance of claim 1 wherein said attachment includes a stop carried thereon, wherein said stop is configured and positioned to engage said generally tubular body to limit insertion of said attachment into said generally tubular body.

3. The dental appliance of claim 2 wherein said threaded affixing shape is positioned immediately adjacent to said stop.

4. The dental appliance of claim 3 wherein said threaded affixing shape of said attachment is configured to be positioned between said first end of said generally tubular body and a distal end of said first oral hygiene dental tool when said attachment is affixed at or adjacent to said first end of said generally tubular body.

5. The dental appliance of claim 1 wherein said threaded shape of said cap is positioned at said first end of said cap.

6. The dental appliance of claim 1 wherein said attachment is affixed to said generally tubular body at or adjacent to the first end of said generally tubular body.

7. The dental appliance of claim 1 wherein said attachment includes means for removably affixing said attachment at or adjacent to the first end of said generally tubular body.

8. The dental appliance of claim 7 wherein said means for attaching includes screw threads.

9. The dental appliance of claim 1 wherein said attachment further comprises a second oral hygiene dental tool extending in an opposite axial direction from said first tool, and wherein said attachment is configured such that said attachment is usable in a first configuration in which said first tool is exposed for use and said second tool is contained within the interior of said generally tubular body, and a second configuration in which said second tool is exposed for use and said first tool is contained within the interior of said generally tubular body.

10. The dental appliance of claim 9 wherein said first and second oral hygiene dental tools each comprise a base portion and a tool portion, each base portion being configured to be removably affixed to said generally tubular body, and the base portions of said first and second oral hygiene dental tools being positioned adjacent one another, said first and second oral hygiene dental tools defining a single unitary member.

11. The dental appliance of claim 1 wherein at least one of said oral hygiene dental tools is a dental scaler or a dental pick.

12. The dental appliance of claim 1 wherein said first end of said cap overlies said second end of said generally tubular body.

13. A self-contained dental appliance comprising:
a generally tubular body having a hollow interior, a first end, and a second end;
an attachment including first oral hygiene dental tool affixable at or adjacent to the first end of said generally tubular body;
a generally tubular cap having a hollow interior, a first end, and a second generally closed end;
an affixing shape positioned on said first oral hygiene dental tool for removably affixing said cap thereto;
said cap including a shape mechanically complementary to said affixing shape for removably affixing said cap to said first oral hygiene dental tool such that said cap covers said first oral hygiene dental tool when said first oral hygiene dental tool is affixed to said generally tubular body in a first configuration; and
cap receiving structure on said generally tubular body for receiving said shape mechanically complementary to said affixing shape on said cap, whereby said cap is usable as a handle extension when said cap is affixed to said generally tubular body coupled to or covering said second end of said generally tubular body in an axially opposite second configuration.

14. The dental appliance of claim 13 wherein said affixing shape is a threaded shape, said shape mechanically complementary to said affixing shape is a threaded shape, and said cap receiving structure is a threaded shape.

15. A dental appliance comprising:
a body having a first end and a second end;
an oral hygiene dental tool removably attachable at or adjacent to the first end of said body; and
a cap, wherein said cap is removably attachable to said oral hygiene dental tool when said oral hygiene dental tool is attached at or adjacent to said first end of said body such that said cap generally covers said oral hygiene dental tool, wherein said cap is also removably attachable at or adjacent to said second end of said body to provide a handle extension thereof.

16. The dental appliance of claim 15 wherein said cap is threadably attachable to said oral hygiene dental tool and threadably attachable at or adjacent to said second end of said body.

17. The dental appliance of claim 15 wherein said oral hygiene dental tool is threadably attachable at or adjacent to said first end of said body.

18. The dental appliance of claim 15 wherein said body is generally hollow and said oral hygiene tool includes a base portion and a pair of dental implements coupled thereto and extending in opposite axial directions thereof such that when said oral hygiene dental tool is attached at or adjacent to said first end of said body, one of said dental implements is received in said hollow body and the other one of said dental implements is positioned externally of said hollow body.

19. The dental appliance of claim 15 wherein said tool includes a stop carried thereon, wherein said stop is configured and positioned to engage said body to limit insertion of said tool into said body.

20. A dental appliance comprising:
a body having a first end and a second end;
an oral hygiene dental tool removably attachable at or adjacent to the first end of said body; and
a cap, wherein said cap is threadably attachable at or adjacent to said to first end of said body to generally cover said oral hygiene dental tool when said oral hygiene dental tool is attached at or adjacent to said first end of said body, wherein said cap is also threadably attachable at or adjacent to said second end of said body to provide a handle extension thereof.
